(19) United States
(12) Patent Application Publication
(10) Pub. No.: US 2025/0279870 A1
(43) Pub. Date: Sep. 4, 2025

(54) METHOD AND APPARATUS FOR GUARD PERIOD OPTIMIZATION FOR SRS ANTENNA SWITCHING

(71) Applicant: Nokia Technologies Oy, Espoo (FI)

(72) Inventors: Hiromasa UMEDA, Tokyo (JP); Juha Pekka KARJALAINEN, Oulu (FI)

(21) Appl. No.: 18/858,733

(22) PCT Filed: Apr. 22, 2022
(86) PCT No.: PCT/EP2022/060695

§ 371 Date: Oct. 21, 2024

(51) Int. Cl. H04L 5/00; H04W 72/0446

(52) U.S. Cl. CPC H04L 5/0094; H04W 72/0446

(57) ABSTRACT

Disclosed are example embodiments of methods and apparatuses for guard period optimization for sounding reference signal (SRS) antenna port switching. A method implemented at a terminal device may comprise transmitting a guard period pattern supported at the terminal device to a network device. The guard period pattern may at least define whether a guard period is placed before a first sounding reference signal (SRS) resource in an SRS resource set and/or whether a guard period is placed after a last SRS resource in the SRS resource set. The method may further include receiving an SRS resource set configuration from the network device. The SRS resource set configuration may include at least one SRS resource set configured according to said guard period pattern.

### TECHNICAL FIELD

Various example embodiments described herein generally relate to communication technologies, and more particularly, to methods and apparatuses for guard period optimization for sounding reference signal (SRS) antenna port switching.

### BACKGROUND

In 5G New Radio (NR), a sounding reference signal (SRS) may be used to estimate uplink (UL) channel quality over a bandwidth or bandwidth part (BWP). When channel reciprocity applies, for example in a time division duplexing (TDD) system, the SRS may also be used to estimate downlink (DL) channel quality.

### SUMMARY

A brief summary of example embodiments is provided below to provide basic understanding of some aspects of various example embodiments. It should be noted that this summary is not intended to identify key features of essential elements or define scopes of the example embodiments, and its sole purpose is to introduce some concepts in a simplified form as a preamble for a more detailed description provided below.

In a first aspect, an example embodiment of a terminal device is provided. The terminal device may comprise at least one processor and at least one memory including computer program code stored thereon. The at least one memory and the computer program code may be configured to, with the at least one processor, cause the terminal device to perform operations including transmitting a guard period pattern supported at the terminal device to a network device. The guard period pattern may at least define whether a guard period is placed before a first sounding reference signal (SRS) resource in an SRS resource set and/or whether a guard period is placed after a last SRS resource in the SRS resource set. The operations may further include receiving an SRS resource set configuration from the network device. The SRS resource set configuration may include at least one SRS resource set configured according to said guard period pattern.

In a second aspect, an example embodiment of a network device is provided. The network device may comprise at least one processor and at least one memory including computer program code stored thereon. The at least one memory and the computer program code may be configured to, with the at least one processor, cause the network device to perform operations including receiving a guard period pattern from a terminal device. The guard period pattern may at least define whether a guard period is placed before a first sounding reference signal (SRS) resource in an SRS resource set and/or whether a guard period is placed after a last SRS resource in the SRS resource set. The operations may further comprise transmitting an SRS resource set configuration to the terminal device. The SRS resource set configuration may include at least one SRS resource set configured according to said guard period pattern.

In a third aspect, an example embodiment of a terminal device is provided. The terminal device may comprise at least one processor and at least one memory including computer program code stored thereon. The at least one memory and the computer program code may be configured to, with the at least one processor, cause the terminal device to perform operations including indicating to a network device that the terminal device supports a guard period placed before a first sounding reference signal (SRS) resource in an SRS resource set and/or after a last SRS resource in the SRS resource set; and receiving, from the network device, information on uplink (UL) resource configuration. The UL resource configuration may include at least antenna ports for symbols before, after and/or within the SRS resource set as well as a request for a guard period position relative to respective SRS resources within the SRS resource set based on the information. The operations may further comprise transmitting a guard period pattern for the UL resource configuration to the network device. The guard period pattern may at least define whether a guard period is placed before the first sounding reference signal (SRS) resource in the SRS resource set and/or whether a guard period is placed after the last SRS resource in the SRS resource set. The operations may further comprise receiving an SRS resource set configuration from the network device. The SRS resource set configuration may include at least one SRS resource set configured according to said guard period pattern.

In a fourth aspect, an example embodiment of a network device is provided. The network device may comprise at least one processor and at least one memory including computer program code stored thereon. The at least one memory and the computer program code may be configured to, with the at least one processor, cause the network device to perform operations including receiving from a terminal device an indication indicating that the terminal device supports a guard period placed before a first sounding reference signal (SRS) resource in an SRS resource set and/or after a last SRS resource in the SRS resource set; and transmitting, to the terminal device, information on uplink (UL) resource configuration. The UL resource configuration may include at least antenna ports for symbols before, after and/or within the SRS resource set as well as a request for a guard period position relative to respective SRS resources in the SRS resource set based on the information. The operations may further comprise receiving, from the terminal device, a guard period pattern for the UL resource configuration. The guard period pattern may at least define whether a guard period is placed before the first sounding reference signal (SRS) resource in the SRS resource set and/or whether a guard period is placed after the last SRS resource in the SRS resource set. The operations may further comprise transmitting an SRS resource set configuration to the terminal device. The SRS resource set configuration may include at least one SRS resource set configured according to said guard period pattern.

Example embodiments of methods, apparatus and computer program products are also provided. Such example embodiments generally correspond to the above example embodiments, and a repetitive description thereof is omitted here for convenience.

Other features and advantages of the example embodiments of the present disclosure will also be apparent from the following description of specific example embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating an example communication network.

FIG. 2 is a schematic diagram illustrating an example antenna port switching for sounding reference signal (SRS) transmissions.

FIG. 3A is a schematic diagram illustrating an example slot configuration for communications between a base station and a UE according to an example embodiment.

FIG. 3B is a schematic diagram illustrating an example slot configuration for communications between a base station and a UE according to an example embodiment.

FIG. 4 is a signaling diagram illustrating example operations for determining an SRS resource set for SRS antenna switching according to an example embodiment.

FIG. 5 is a schematic diagram illustrating various example guard period patterns according to an example embodiment.

FIG. 6 is a schematic diagram illustrating various example guard period patterns according to an example embodiment.

FIG. 7 is a signaling diagram illustrating example operations for determining an SRS resource set for SRS antenna switching according to an example embodiment.

FIG. 8 is a schematic diagram illustrating an example antenna port transition and corresponding determination of a guard period according to an example embodiment.

FIG. 9 illustrates a structural block diagram of a communication system according to an example embodiment.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “terminal device” or “user equipment” (UE) refers to any entities or devices that can wirelessly communicate with the network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a UE, a user terminal, a mobile terminal, a mobile station, or a wireless device.

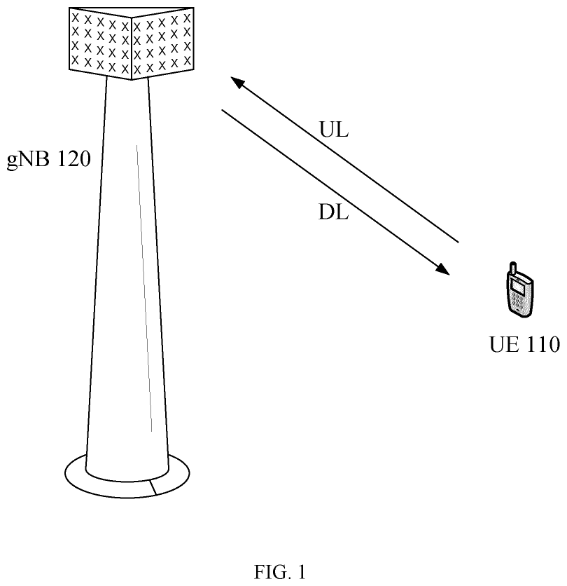

FIG. 1 illustrates a schematic diagram of an example communication network 100, such as a 5G NR network, in which aspects of the present disclosure may be performed. Referring to FIG. 1, the communication network 100, which may be a part of a larger network, may include a base station 120 shown as gNB and a user equipment (UE) device 110 which communicates with the gNB 120 on uplink (UL) and downlink (DL) channels. The gNB 120 may include a number of antenna elements and support multiple-input multiple-output (MIMO) technologies including for example spatial multiplexing, beam-forming and/or transmit diversity. The UE 110 may have multiple antenna ports which correspond to different communication channels, and channel quality for one antenna port may be different from channel quality for another antenna port. The UE 110 may be configured to transmit sounding reference signals (SRSs) on SRS resources (e.g. one or more OFDM symbols where the SRS is transmitted) to the gNB 120, and the number of the SRSs and/or the SRS resources may be determined based on the number of antenna ports. The gNB 120 may measure the channel quality based on the received SRSs.

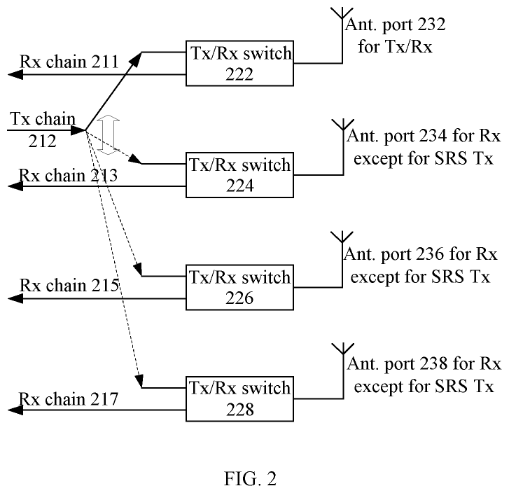

FIG. 2 is a schematic diagram illustrating example uplink SRS transmissions on multiple antenna ports. In the example shown in FIG. 2, the UE 110 may have four antenna ports 232, 234, 236, 238, which are connected to Tx/Rx switches 222, 224, 226, 228, respectively. It is assumed that the UE 110 supports antenna switching capability “t1r4” for a TDD carrier component (CC) or band, where “t1” means that the UE 110 have only one transmit (Tx) chain, and “r4” means that the UE 110 can use up to four receive (Rx) chains. The antenna port 232 may be configured to transmit and receive signals, while the antenna ports 234, 236, and 238 may be configured to receive signals only except for SRS transmissions. In the example, since the number of Tx chains is less than the number of Rx antennas, the UE 110 needs to switch the Tx chain from the antenna ports 232 to the antenna ports 234, 236, 238 so as to sound spatial channels from all the Rx antennas, as shown in FIG. 2. For example, the SRS signals may be transmitted on the four antennas in turn, and one antenna is selected by the respective switch for transmission at a time.

The number of SRS resources needed to sound each of the antenna ports may depend on the number of Tx chains and Rx antenna ports of the UE. For example, a UE with 1T4R capability may require 4 SRS resources to sound all 4 RX antenna ports, while a UE with 2T4R may require only 2 SRS resources to sound all 4 antenna ports. According to 3GPP technical specification, a guard period of Y symbols may be needed for the SRS antenna switching, in which the UE 110 does not transmit any other signals. The below Table 1 shows the minimum guard period requirements. Referring to Table 1, when a subcarrier spacing (SCS) Δf is less than 120 kHz, the minimum guard period is one OFDM symbol, and when the subcarrier spacing Δf is 120 kHz, the minimum guard period is two OFDM symbols. It means that the UE 110 should have an ability to complete the SRS antenna switching within one or two OFDM symbols.

TABLE 1
The minimum guard period Y

| μ | Δf = 2^{μ} · 15 [kHz] | Y [symbol] |
|---|---|---|
| 0 | 15 | 1 |
| 1 | 30 | 1 |
| 2 | 60 | 1 |
| 3 | 120 | 2 |

The network has choices in configuring which switching pattern with the UE depending on considering the required power and time to take sounding all the channels. For example, comparing 1T4R and 4T4R, in terms of power, the latter does not deliver high power than the former due to the fact that the power is shared across four antennas, i.e., the power per antenna port for the latter becomes ¼ of the power for the former; whereas in terms of time, the former takes four times compared to the latter. In other words, more power per antenna port requires more frequent switching occasions and hence, more gaps in-between SRS resources for SRS antenna switching. Furthermore, in NR release 17, more UE antenna switching capabilities are standardized (e.g., xT6R and xT8R, where x=1, 2, 4). As a result, the dilemma between time and power per antenna port expands when it comes to considering those new scenarios.

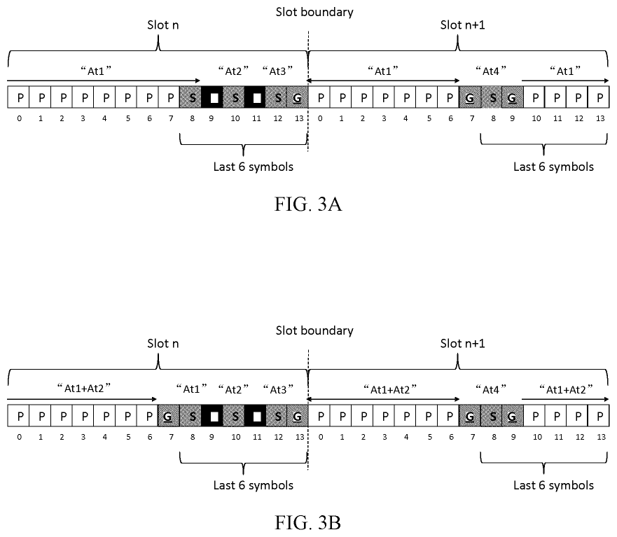

In some occasions, it may be desirable for the UE 110 to transmit with high antenna power so as to achieve reliable communication, for example, when the UE 110 is at a cell edge. Current 3GPP specifications, however, may not support some practical implementation aspects. For example, referring to FIG. 3A, assuming the UE 110 is configured with 1T4R antenna switching supporting one Tx antenna and four Rx antennas, four SRS resources are needed to sound all the four Rx antenna ports. As shown in FIG. 3A, in case where the SRS resource is limited to the last 6 symbols of the slot and the other symbols are allocated for physical channel (e.g., PUSCH, PUCCH) transmission, the four SRS resources can be transmitted in different symbols of two different slots. More specifically, three of the four SRS resources are transmitted within a slot n and the rest is transmitted within a slot n+1. Further, assuming the UE's Tx chain performance varies for the different four antennas, for example, in the order of At1>At2>At3>At4, the UE 110 may want to use At1 as much as possible. Referring to FIG. 3A, a practical solution is to allocate the first three SRS resources in symbol 8, symbol 10, symbol 12 of slot n, for antennas At1, At2, At3, respectively. Two guard periods (in symbol 9, symbol 11) are inserted between individual SRS resources to allow time for the Tx chains to switch between different Rx antenna ports. The fourth SRS resource is allocated in symbol 8 of slot n+1, and two guard periods are provided before and after the SRS resource to allow switching between antennas At1 and At4. However, the current 3GPP specifications do not explicitly allow two guard periods on symbol 13 in slot n and symbol 7 in slot n+1, as shown in underline. In addition, the guard period on symbol 9 in slot n+1 is clearly not allowed, as the technical specifications require that the guard period is in-between the SRS resources of the set.

The impact of uncertain location of the guard periods would become more severe in scenarios of carrier aggregation (CA) or multi-RAT dual connectivity (MR-DC). Assuming a CA scenario where one TDD band and four FDD bands are aggregated on the UE 110 and the five bands share the antennas, four UL symbols of the TDD band are lost and (4UL symbols+4DL symbols)*4 bands=32 symbols are lost for the other FDD bands. Because the gNB 120 has no clue to identifying where the antenna switching occurs over the four symbols, it would avoid schedule any UL transmission or DL reception for the UE 110 in any one of the four symbols, causing negative impact on the system capacity.

There are other cases where guard periods are necessary whenever antenna configurations change before and/or after respective SRS resources. For example, referring to FIG. 3B, in case that the UE 110 with 1T4R wants to use Tx diversity with At1 and At2 as much as possible, the UE 110 may transmit the physical channel (e.g., PUSCH or PUCCH) until symbol 6 in slot n and slot n+1 with the Tx diversity. As shown in FIG. 3B, it is needed to provide two guard periods on symbol 7 in slot n and symbol 9 in slot n+1, as well as two guard periods in-between SRS resources of symbol 12 in slot n and symbol 8 in slot n+1. However, the current specifications would not allow the UE 110 to have guard periods on symbol 7 in slot n, symbol 9 in slot n+1 and either of symbol 13 in slot n or symbol 9 in slot n+1.

Thus, a problem may occur for current specifications that only specify a guard period in-between SRS resources within a SRS resource set while in practice, the guard periods may be necessary before and/or after each SRS resource to allow the UE to utilize the best antennas when it transmits other channels than SRS. The problem becomes even more severe in occasions where more flexible SRS resources allocations are allowed, for example, the SRS resources can be configured into any symbol position in a slot.

Various example embodiments described herein may address one or more of the above problems by lifting the restriction to provide guard periods only in-between SRS resources within an SRS resource set. The example embodiments can be implemented to enhance the uplink SRS operations, for UEs e.g., with more than 4Rx antenna ports. In addition, the multiple antenna ports may be leveraged to improve the UE's performance.

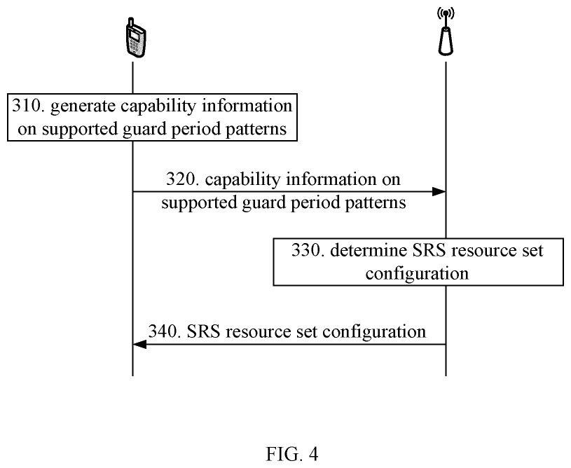

FIG. 4 is a signaling diagram illustrating example operations for determining an SRS resource set for SRS antenna switching according to an example embodiment. In some implementations, the operations shown in FIG. 4 may be performed by the UE 110 and the gNB 120 shown in FIG. 1.

Referring to FIG. 4, at 310, the UE 110 may generate a UE capability information. For example, the UE capability information may indicate whether the UE 110 is capable of providing one or more guard periods before and/or after one or more SRS resources within an SRS resource set, and the ways the UE 110 is supporting to provide the guard periods before and/or after the SRS resources. When the capability information indicates that UE 110 is able to place a guard period before and/or after an SRS resource, and if the physical antenna to transmit symbols before and/or after the respective SRS resource is different from the antenna to transmit the SRS, then the UE 110 is allowed to have guard periods before and/or after the SRS resource.

In an example embodiment, the UE capability information may be generated in response to a request by the gNB 120. For example, the gNB 120 may transmit an instruction to request the UE 110 to report one or more supported guard period patterns (hereinafter referred to as “GP pattern”). In response, the UE 110 generates the UE capability information on the supported GP patterns. It would be appreciated that the GP pattern refers to a setting rule or standard to determine if a guard period can be provided before and/or after the SRS resources. Some examples of the GP pattern will be discussed in detail later. For example, the GP pattern may at least define whether a guard period is placed before the first SRS sources in an SRS resource set and/or whether a guard period is placed after the last SRS resource in the SRS resource set.

In an example embodiment, the gNB 120 may be pre-configured with one or more GP patterns indicating whether or not a guard period can be placed before and/or after each SRS resource within an SRS resource set. For example, the gNB 120 may broadcast system information including the GP patterns, and the UE 100 is aware of the information when it camps on a cell served by the gNB 120. Alternatively, the gNB 120 may transmit the GP patterns in a radio resource control (RRC) configuration or re-configuration message. The gNB 120 may request the UE 110 to follow one or more GP patterns, then the UE 110 may generate a feedback report as the capability information.

At 320, the UE 110 may transmit to the gNB 120 and the gNB 120 may receive, capability information indicating one or more GP patterns that the UE 110 supports. For example, the GP patterns may indicate a certain capability of the UE 110 to place or insert a guard period before and/or after each SRS resource within an SRS resource set.

In an example embodiment, the UE 110 may actively transmit the supported GP pattern to the gNB 120 e.g. during initial attachment to the network, or transmit the supported GP pattern in response to an enquiry received from the gNB 120. For example, the UE 110 may transmit a parameter (e.g., via an RRC signaling) to the gNB 120 to indicate that the UE 110 is capable of supporting one or more GP patterns, and thus is able to provide guard periods before and/or after the SRS resource within an SRS resource set.

Then at 330, the gNB 120 may determine an SRS resource set configuration. The SRS resource set configuration may be based at least on the received information on UE-supported GP patterns. In an example embodiment, the SRS resource set configuration may include one or more SRS resource set, and indicate the number of SRS resources included in the SRS resource set, as well as the time slots, symbols, and other parameters related to the SRS resources. For example, an SRS resource may occupy one or more (e.g. 1, 2, or 4) consecutive OFDM symbols e.g. within the last 6 symbols of a slot. In some embodiments, the SRS resource may also occupy any other symbols within a slot. Among the one or more SRS resource sets, at least one SRS resource set may be configured for SRS antenna switching as discussed above with reference to FIG. 2.

By way of example, referring to FIG. 3B, when the gNB 120 is aware that the UE 110 is capable of providing the guard periods before and after an SRS symbol, the gNB 120 may allocate the SRS resources for the UE 110 as shown in FIG. 3B, i.e., the first SRS and the last SRS are allocated to be in symbol 8 of slot n and slot n+1, respectively. Otherwise, when the UE 110 cannot provide the guard periods before or after an SRS symbol, the gNB 120 may adopt another way to allocate the SRS resources to the UE 110.

At 340, the gNB 120 may transmit to the UE 110 and the UE 110 may receive the SRS resource set configuration. In an example embodiment, the UE 110 may receive the configuration in association with a high layer message. For example, the SRS resource set configuration may be received by the UE 110 via a higher layer parameter SRS-ResourceSet, and information on the SRS resources is configured by for example a higher layer parameter SRS-Resource. When the UE 110 is configured with a higher layer parameter usage in SRS-ResourceSet set as “antennaSwitching”, the SRS resource set is configured for the antenna switching. The SRS resource set for antenna switching may include two or more SRS resources for SRS transmissions on different antenna ports, and antenna switching is needed between two SRS resources that are associated with different antenna ports.

Thereafter, the UE 110 may generate one or more SRS symbols based on the received configuration message. In addition, the UE 110 may place one or more guard periods before and/or after the SRS symbols, for example, according to the GP pattern that the UE 110 supports.

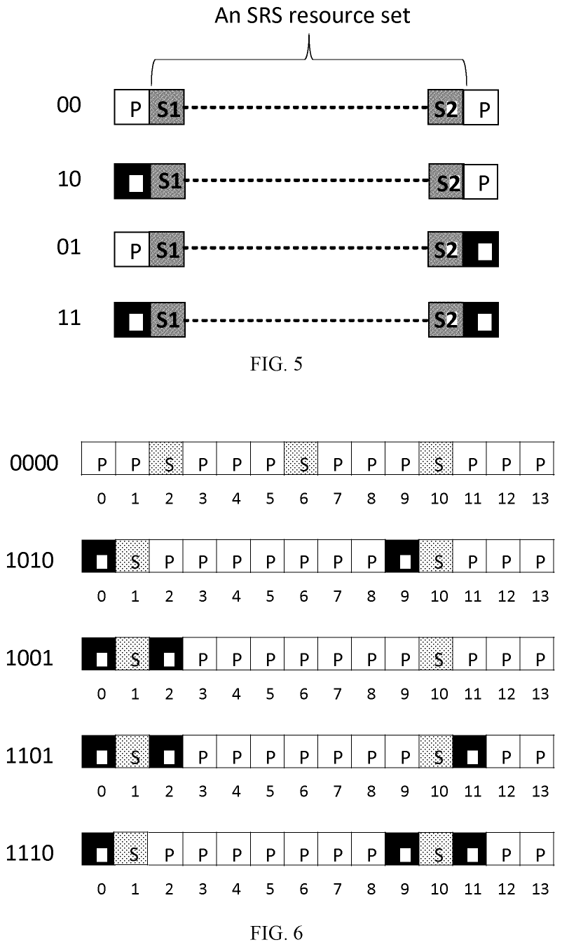

For better understanding of the above operations, some examples of the guard period patterns will be discussed below with reference to FIGS. 5 and 6. Referring to FIG. 5, in some examples, the SRS resource set configured for the UE 110 may include a plurality of SRS resources, starting at the first SRS indicated as “S1” and ending with the last SRS indicated as “S2”. The SRS resources S1 and S2 may be configured in the same slot or in different slots.

As shown in FIG. 5, four GP patterns may be defined for the SRS resource set. In an example embodiment, a bitmap with two bits may be used to indicate the GP patterns. For example, Bits “00” indicate that no guard period is allowed immediately before the first SRS resource S1 nor immediately after the last SRS resource S2; Bits “10” indicate that a guard period can be placed immediately before the first SRS resource S1 but no guard period is allowed immediately after the last resource S2; Bits “01” indicate a guard period can be placed immediately after the last SRS resource S2 but no guard period is allowed to be placed immediately before the first SRS resource S1; and Bits “11” indicate that the UE 110 is capable of placing guard periods immediately before the first SRS resource S1 and immediately after the last SRS resource S2. For example, in the operation 320 of FIG. 4, the UE 110 may inform the gNB 120 of one or more supported GP patterns by transmitting the bits. Then the gNB 120 may determine the SRS resource set configuration based on the received bits in the operation 330.

In some example embodiments, the UE 110 may further support switching antennas between the first SRS resource and the last SRS resource within an SRS resource set, so that the UE can make best use of the antennas. FIG. 6 is a schematic diagram illustrating various example guard period patterns according to an example embodiment. As shown in FIG. 6, if a gap between two adjacent SRS resources within the SRS resource set is wider than a minimum guard period (e.g., as defined in above Table 1), i.e., the gap is larger than 1 symbol when the subcarrier spacing Δf of the serving band is less than 120 kHz, or the gap is larger than 2 symbols when the Δf is 120 kHz, a guard period can be placed between the two adjacent SRS resources. For instance, if the gap between the first SRS resource and the last SRS resource is wider than a minimum guard period multiplied by two, the UE may further place one or more guard periods inside the first SRS resource and the last SRS resource.

Referring to FIG. 6, in an example embodiment, four bits may be used to indicate the GP patterns. For example, the first pair of bits may be determined with reference to FIG. 5, i.e., based on whether or not the UE support guard period immediately before the first SRS resource and immediately after the last SRS resource. Further, the last pair of bits may be used to indicate the GP patterns between the first and the last SRS resources within an SRS resource set. For example, Bit “00” indicate that no guard period is allowed immediately before the last SRS resource nor immediately after the first SRS resource; Bits “10” indicate that a guard period is placed immediately before the last SRS resource; Bits “01” indicate that a guard period is placed immediately after the first SRS resource; and Bits “11” indicate that the UE 110 is capable of placing guard periods immediately after the first SRS resource and immediately before the last SRS resource.

Some example of the guard period pattern have been discussed above with reference to FIGS. 5-6. It would be appreciated that the present disclosure is not limited in any way to the examples, and the GP pattern may also be represented in other form so long as it can indicate the UE's capability to place a guard period before and/or after an SRS resource.

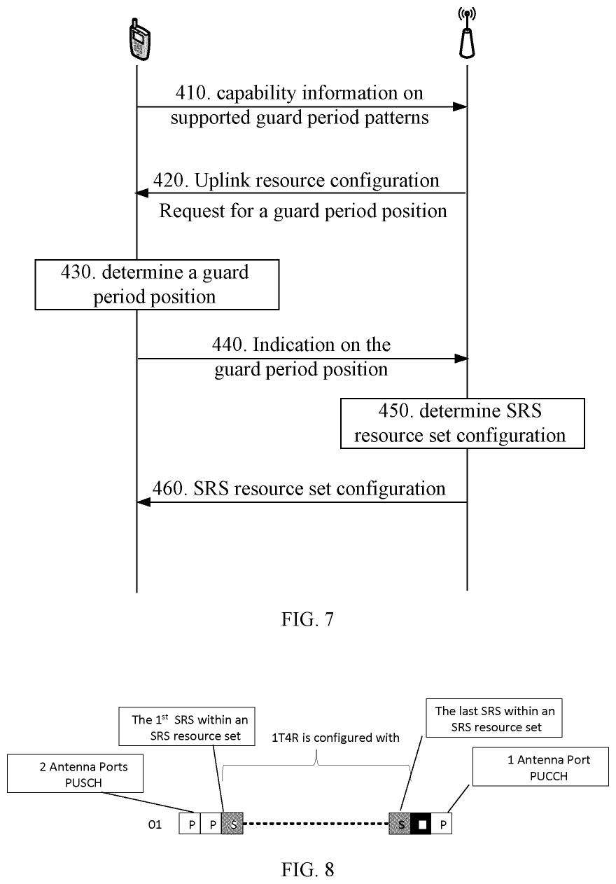

FIG. 7 is a signaling diagram illustrating example operations for determining an SRS resource set for SRS antenna switching according to an example embodiment. The operations shown in FIG. 7 may be performed for example by the UE 110 and the gNB 120 shown in FIG. 1.

Referring to FIG. 7, at 410, the UE 110 may generate and transmit the capability information on the supported GP patterns to the gNB 120. The GP patterns may indicate the UE 110 support a guard period placed before the first SRS resource and/or after the last SRS resource within an SRS resource set. Details of the operation 410 may refer to the operation 320 discussed above with respect to FIG. 4, and a repetitive description thereof is omitted here.

At 420, the gNB 120 may transmit, and the UE 110 may receive information on uplink (UL) resource configuration. The UL resource configuration information may include at least antenna ports for the uplink transmissions, e.g., the symbols before, after and/or within an SRS resource set. In addition, the gNB 120 may also transmit, and the UE 110 may receive a request for a guard period position relative to the SRS resources within the SRS resource set based on the UL resource configuration information. For example, the configuration information and/or the request may be transmitted/received through higher layer signaling (e.g., RRC signaling, MAC-CE) and/or physical layer signaling (e.g., L1).

In an example embodiment, the configuration information may include one or more lists of antenna ports. Each list of the antenna ports may include one or more antenna ports used for the transmission of symbols before the first SRS resource, after the last SRS resource, and/or within the SRS resource set, respectively. In addition, for each list of the antenna ports, the gNB 120 may transmit a request to the UE 110 to determine a corresponding preferred guard position.

Table 2 shows an example of the UL resource configuration information and corresponding preferred guard period position. In Table 2, the configuration information includes the number of antenna ports before the first SRS and the last SRS, as well as the SRS resource configuration. Although only six lists (rows) of antenna ports information are provided, it would be appreciated that other possible configurations can also be provided to the UE 110. Also it would be appreciated that all or part of the configuration information may be transmitted to the UE 110.

TABLE 2
UL resource configuration and preferred GP position

| | SRS resource | | |
|---|---|---|---|
| Before the | configuration | After the | GP position |
| first SRS | xTyR within an | last SRS | (before the first SRS, |
| resource | SRS resource set | resource | after the last SRS) |
| 2-AP | 1T4R | 1-AP | 01 |
| 2-AP | 1T4R | 2-AP | 01 |
| 2-AP | 1T4R | 4-AP | 01 |
| 2-AP | 2T4R | 1-AP | 01 |
| 2-AP | 2T4R | 1-AP | 00 |
| 2-AP | 4T4R | 1-AP | 10 |

When the UE 110 receives the request, at 430, it may determine a GP position for the UL resource configuration. Similar to the GP pattern as discussed above, the GP position defines whether a guard period is placed before the first SRS source and/or whether a guard period is placed after the last SRS resource within an SRS resource set.

The UE 110 may determine the GP position by taking account of various factors. For example, the UE 110 may determine the GP position in a way so that the best antenna can be used as much as possible or the power spectral density (PSD) can be increased, as depicted with reference to FIGS. 3A-3B. Additionally or alternatively, the GP position may be determined based on the antenna port transitions included in the UL resource configuration information. For example, the GP position can be determined so that additional guard periods can be avoided in order to increase the entire network performance.

At 440, the UE 110 may transmit the GP position to the gNB 120. In an example embodiment, the UE 110 may report the GP position by using a bitmap which may include at least two bits indicating whether a guard period is preferred (=1) or not (=0) to be placed before the first SRS resource and/or after the last SRS resource in the SRS resource set. For example, the UE 110 may transmit a GP pattern to indicate the preferred GP position.

For example, FIG. 8 illustrates an example antenna port transition and corresponding determination of a guard period according to an example embodiment, which corresponds to the top row of Table 2. As shown in FIG. 8, the UE 110 is configured with 1T4R antennas, and is further configured to transmit PUSCH before the SRS resource set using 2 antenna ports (2-AP), and to transmit PUCCH after the SRS resource set using 1 antenna port (1-AP). It is noted that that logical 1-AP transmission, due to precoding, can be associated with multiple physical UE antenna ports. For this specific antenna port transition (2-AP→1T4R→1-AP), the UE 110 may report a pair of bit fields “01” indicating that a guard period is preferred after the last SRS resource, but no guard period is needed before the first SRS resource within an SRS resource set.

In some example embodiments, when the gNB 120 desires to schedule or configure other UL data/control signal between the first and last SRS resources, additional antenna port transition may be defined within the SRS resource set, as depicted in FIG. 6. In this case, two additional bits may be used to indicate whether a guard period is placed, between the first SRS resource and the last SRS resource within the SRS resource set, before and/or after the respective SRS resources in the SRS resource set. The GP positions may be represented in the forms shown in FIG. 6, thus explanation thereof will be omitted here.

Referring back to FIG. 7, with the received indication on the GP positions, the gNB 120 may, at 450 and 460, configure and transmit an SRS resource set configuration to the UE 110. Based on the received information, the gNB 120 is aware of the preferred GP positions subject to different UL signals/channels when different antenna port configurations are used before and after UL SRS transmission, which enables the gNB 120 to configure the SRS resource in an optimized manner. Also individual UE's performance can be maximized when the UE 110 places the preferred GPs as it reports to the gNB 120 in operation 440. Details of the operation 450, 460 may refer to the operation 330, 340 discussed above with respect to FIG. 4, and a repetitive description thereof is omitted here.

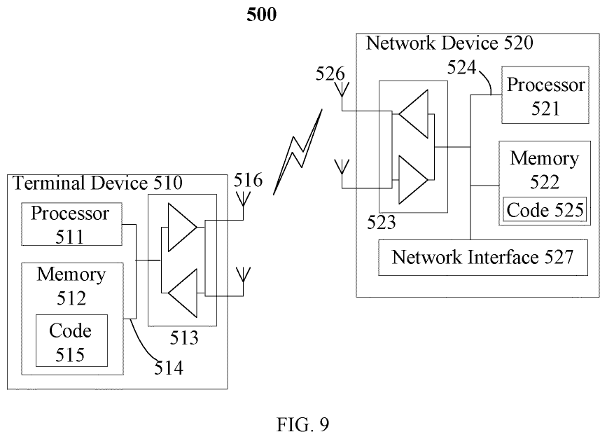

FIG. 9 is a block diagram illustrating an example communication system 500 in which example embodiments of the present disclosure can be implemented. As shown in FIG. 9, the communication system 500 may include a terminal device 510 which may be implemented as the UE 110 discussed above, and a network device 520 which may be implemented as the gNB 120 discussed above. Although FIG. 9 shows only one network device 120, it would be appreciated that the terminal device 510 may wirelessly communicate with two network devices for example in an MR-DC scenario.

Referring to FIG. 9, the terminal device 510 may comprise one or more processors 511, one or more memories 512 and one or more transceivers 513 interconnected through one or more buses 514. The one or more buses 514 may be address, data, or control buses, and may include any interconnection mechanism such as series of lines on a motherboard or integrated circuit, fiber, optics or other optical communication equipment, and the like. Each of the one or more transceivers 513 may comprise a receiver and a transmitter, which are connected to a plurality of antennas 516. The terminal device 510 may wirelessly communicate with the network device 520 through the plurality of antennas 516. The one or more memories 512 may include computer program code 515. The one or more memories 512 and the computer program code 515 may be configured to, when executed by the one or more processors 511, cause the terminal device 510 to perform operations and procedures relating to the UE 110 as described above.

The network device 520 may comprise one or more processors 521, one or more memories 522, one or more transceivers 523 and one or more network interfaces 527 interconnected through one or more buses 524. The one or more buses 524 may be address, data, or control buses, and may include any interconnection mechanism such as a series of lines on a motherboard or integrated circuit, fiber, optics or other optical communication equipment, and the like. Each of the one or more transceivers 523 may comprise a receiver and a transmitter, which are connected to a plurality of antennas 526. The network device 520 may operate as a base station for the terminal device 510 and wirelessly communicate with the terminal device 510 through the plurality of antennas 526. The one or more network interfaces 527 may provide wired or wireless communication links through which the network device 520 may communicate with other network devices, entities or functions. The one or more memories 522 may include computer program code 525. The one or more memories 522 and the computer program code 525 may be configured to, when executed by the one or more processors 521, cause the network device 520 to perform operations and procedures relating to the gNB 120 as described above.

The one or more processors 511, 521 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 511, 521 may be configured to control other elements of the terminal/network device and operate in cooperation with them to implement the procedures discussed above.

The one or more memories 512, 522 may include at least one tangible storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 512, 522 may include but not limited to an electric, a magnetic, an optical, an electromagnetic, an infrared, or a semiconductor system, apparatus, or device or any combination of the above.

The network device 520 can be implemented as a single network node, or disaggregated/distributed over two or more network nodes, such as a central unit (CU), a distributed unit (DU), a remote radio head-end (RRH), using different functional-split architectures and different interfaces.

It would be understood that blocks in the drawings may be implemented in various manners, including software, hardware, firmware, or any combination thereof. In some example embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some example embodiments further provide computer program code or instructions which, when executed by one or more processors, may cause a device or apparatus to perform the procedures described above. The computer program code for carrying out procedures of the example embodiments may be written in any combination of one or more programming languages. The computer program code may be provided to one or more processors or controllers of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

Some example embodiments further provide a computer program product or a computer readable medium having the computer program code or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single example embodiment. Conversely, various features that are described in the context of a single example embodiment may also be implemented in multiple example embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

Abbreviations used in the description and/or in the figures are defined as follows:

| | |
|---|---|
| AP | Antenna Port |
| AS | Antenna Switching |
| BS | Base Station |
| CA | Carrier Aggregation |
| DL | Downlink |
| FDD | Frequency Division Duplex |
| gNB | next Generation Base Station |
| GP | Guard Period |
| MR-DC | Multi-RAT Dual Connectivity |
| NR | New Radio |
| OFDM | Orthogonal Frequency Division Multiplexing |
| PUCCH | Physical Uplink Control Channel |
| PUSCH | Physical Uplink Shared Channel |
| PDCCH | Physical Downlink Control Channel |
| RRC | Radio Resource Control |
| SCS | Subcarrier Spacing |
| SRS | Sounding Reference Signal |
| TDD | Time Division Duplex |
| UE | User Equipment |
| UL | Uplink |

1. A terminal device comprising:
at least one processor; and
at least one memory including computer program code, the at least one memory and the computer program code that, when executed by the at least one processor, cause the terminal device to:
transmit a guard period pattern supported at the terminal device to a network device, said guard period pattern at least defining whether a guard period is placed before a first sounding reference signal (SRS) resource in an SRS resource set and/or whether a guard period is placed after a last SRS resource in the SRS resource set; and
receive an SRS resource set configuration from the network device, the SRS resource set configuration including at least one SRS resource set configured according to said guard period pattern.

2. The terminal device according to claim 1, wherein said guard period pattern includes at least one of the following patterns that: no guard period immediately before the first SRS resource nor immediately after the last SRS resource, or at least one guard period immediately before the first SRS resource and/or immediately after the last SRS resource, within an SRS resource set.

3. The terminal device according to claim 1, wherein said guard period pattern further defines whether a guard period is placed, between the first SRS resource and the last SRS resource within the SRS resource set, before and/or after respective SRS resources in the SRS resource set.

4. The terminal device according to claim 3, wherein when a guard period is placed between two adjacent SRS resources within the SRS resource set, a gap between the two adjacent SRS resources is wider than a minimum guard period.

5. A network device comprising:
at least one processor; and
at least one memory including computer program code, the at least one memory and the computer program code that, when executed by the at least one processor, cause the network device to:
receive a guard period pattern from a terminal device, said guard period pattern at least defining whether a guard period is placed before a first sounding reference signal (SRS) resource in an SRS resource set and/or whether a guard period is placed after a last SRS resource in the SRS resource set; and
transmit an SRS resource set configuration to the terminal device, the SRS resource set configuration including at least one SRS resource set configured according to said guard period pattern.

6. The network device according to claim 5, wherein said guard period pattern includes at least one of the following patterns that: no guard period immediately before the first SRS resource nor immediately after the last SRS resource, or at least one guard period immediately before the first SRS resource and/or immediately after the last SRS resource, within an SRS resource set.

7. The network device according to claim 5, wherein said guard period pattern further defines whether a guard period is placed, between the first SRS resource and the last SRS resource within the SRS resource set, before and/or after respective SRS resources in the SRS resource set.

8. The network device according to claim 7, wherein when a guard period is placed between two adjacent SRS resources in the SRS resource set, a gap between the two adjacent SRS resources is wider than a minimum guard period.

9. A terminal device comprising:
at least one processor; and
at least one memory including computer program code, the at least one memory and the computer program code that, when executed by the at least one processor, cause the terminal device to:
indicate to a network device that the terminal device supports a guard period placed before a first sounding reference signal (SRS) resource in an SRS resource set and/or after a last SRS resource in the SRS resource set;
receive, from the network device, information on uplink (UL) resource configuration including at least antenna ports for symbols before, after and/or within the SRS resource set as well as a request for a guard period position relative to respective SRS resources within the SRS resource set based on the information;
transmit a guard period pattern for the UL resource configuration to the network device, the guard period pattern at least defining whether a guard period is placed before the first sounding reference signal (SRS) resource in the SRS resource set and/or whether a guard period is placed after the last SRS resource in the SRS resource set; and
receive an SRS resource set configuration from the network device, the SRS resource set configuration including at least one SRS resource set configured according to said guard period pattern.

10. The terminal device according to claim 9, wherein said guard period pattern includes at least one of the following patterns: no guard period immediately before the first SRS resource nor immediately after the last SRS resource, or at least one guard period immediately before the first SRS resource and/or immediately after the last SRS resource within the SRS resource set.

11. The terminal device according to claim 9, wherein said guard period pattern further defines whether a guard period is placed, between the first SRS resource and the last SRS resource within the SRS resource set, before and/or after respective SRS resources in the SRS resource set.

12. The terminal device according to claim 9, wherein said request is received via at least one of RRC, MAC or L1 signaling from the network device.

13. The terminal device according to claim 11, wherein said guard period pattern is represented by a bitmap including at least two bits indicating whether a guard period is placed before the first SRS resource and/or after the last SRS resource in the SRS resource set and at least two additional bits indicating whether a guard period is placed, between the first SRS resource and the last SRS resource within the SRS resource set, before and/or after respective SRS resources in the SRS resource set.

14-44. (canceled)
